(19) United States
(12) Patent Application Publication
(10) Pub. No.: US 2013/0156500 A1
(43) Pub. Date: Jun. 20, 2013

(54) CORNER BRACKET

(71) Applicant: Richard Grossman, Newberg, OR (US)

(72) Inventor: Richard Grossman, Newberg, OR (US)

(21) Appl. No.: 13/710,151

(22) Filed: Dec. 10, 2012

Related U.S. Application Data
(60) Provisional application No. 61/570,726, filed on Dec. 14, 2011.

(51) Int. Cl. F16B 12/44

(52) U.S. Cl. CPC F16B 12/44
USPC 403/403

(57) ABSTRACT

A corner bracket. The corner bracket includes a bottom edge and an outside edge, where the outside edge includes a bend. The corner bracket also includes an inside edge, where the inside edge includes a bend. The angle of the bend in the outside edge is the same as the angle of the bend in the inside edge.

### CROSS-REFERENCE TO RELATED APPLICATIONS

This application claims the benefit of and priority to U.S. Provisional Patent Application Ser. No. 61/570,726 filed on Dec. 14, 2011, which application is incorporated herein by reference in its entirety.

### BACKGROUND OF THE INVENTION

In many instances, a user seeks to build a structure for temporary use. For example, the user may be building a temporary garden bed, a sandbox, a temporary support or other structure. In these instances, the user may prefer or require a corner with a specific angle. However, the user may prefer not to spend a high amount of time preparing the corner. This may be true even in permanent structures.

There are corner brackets that allow users to prepare a corner. However, these brackets suffer from a number of drawbacks. For example, many of the brackets are permanent. That is, they require a high amount of work to remove from the structure. This can be extremely inconvenient if the user seeks to quickly move or disassemble the structure.

In addition, many of the brackets are molded. This means that the bracket is in its final shape before being shipped or moved. The final shape of the bracket is often not conducive to packing. I.e., the brackets do not fit well against one another, leaving a lot of empty space within any packing scheme.

Accordingly, there is a need in the art for a corner bracket that can be shipped in a more compact manner. In addition, there is a need in the art for the corner bracket to allow temporary connections.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a corner bracket. The corner bracket includes a bottom edge and an outside edge, where the outside edge includes a bend. The corner bracket also includes an inside edge, where the inside edge includes a bend. The angle of the bend in the outside edge is the same as the angle of the bend in the inside edge.

Another example embodiment includes a corner bracket. The corner bracket includes a bottom edge and an outside edge, where the outside edge includes a bend. The corner bracket also includes an inside edge, where the inside edge includes a bend. The angle of the bend in the outside edge is the same as the angle of the bend in the inside edge. The corner bracket further includes a tab, where the tab secures a portion of the bottom edge to the outside edge.

Another example embodiment includes a corner bracket. The corner bracket includes a bottom edge and an outside edge, where the outside edge includes a first bend. The corner bracket also includes an inside edge, where the inside edge includes a second bend. The angle of the first bend is the same as the angle of the second bend. The corner bracket further includes a tab, where the tab secures a portion of the bottom edge on a first side of the first bend to the outside edge on a second side of the first bend.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a top view of the example of a corner bracket;

FIG. 1B is an inside view of the example of a corner bracket; and

FIG. 1C is an outside view of the example of a corner bracket;

FIG. 2A illustrates an inside view of the example of a corner bracket in use; and

FIG. 2B illustrates an outside view of the example of a corner bracket in use.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

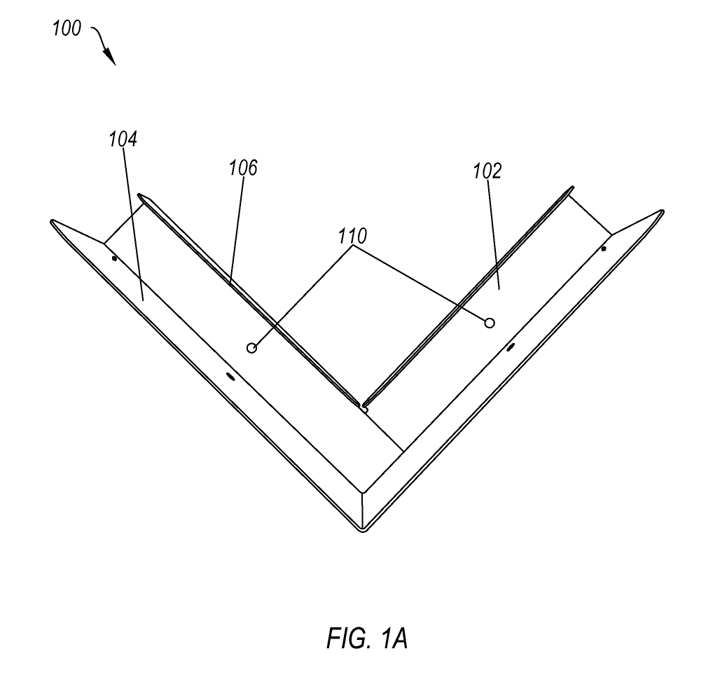

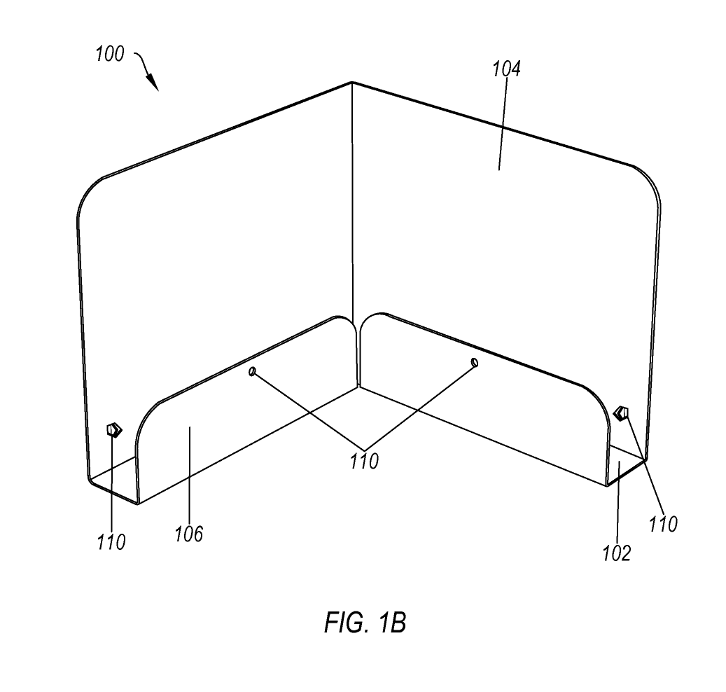

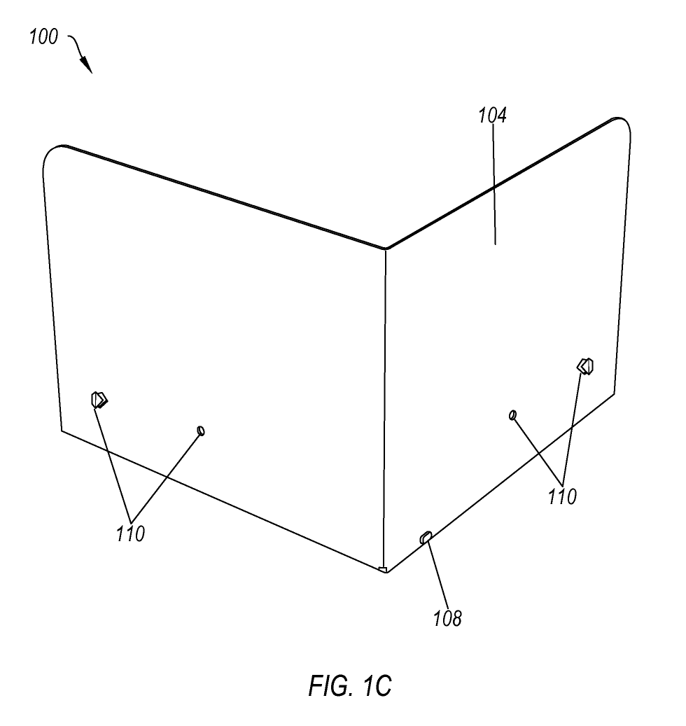

FIGS. 1A, 1B and 1C illustrate an example of a corner bracket 100. FIG. 1A is a top view of the example of a corner bracket 100; FIG. 1B is an inside view of the example of a corner bracket 100; and FIG. 1C is an outside view of the example of a corner bracket 100. In at least one implementation, the corner bracket 100 can be used to create a corner with two boards. I.e., the corner bracket 100 can form a corner from two boards or other building material. The corner bracket 100 can be used for a temporary or permanent connection, as desired by the user. In addition, the corner bracket 100 can be installed without the use of tools and/or external hardware, such as screws, bolts or other fasteners. This allows the corner bracket 100 to be quickly and conveniently installed.

FIGS. 1A, 1B and 1C show that the corner bracket 100 can include a bottom edge 102. In at least one implementation, the bottom edge 102 can support the boards. In particular, the boards, once inserted, rest on the bottom edge 102 of the corner bracket 100. The bottom edge 102 can ensure that the boards are level along the bottom or in any other desired spatial relationship to one another. Additionally or alternatively, the corner bottom edge 102 can be attached to an external device or area. For example, the bottom edge 102 can be anchored to a floor, wall, the ground or any other desired area.

FIGS. 1A, 1B and 1C also show that the corner bracket 100 can include an outside edge 104. In at least one implementation, the outside edge 104 can prevent lateral movement of the boards toward the obtuse angle of the corner bracket 100. I.e., the outside edge 104 can ensure that the boards do not separate from one another. The outside edge 104 can include a bend. The bend can form the angle of the corner. I.e., the outside edge 104 can include a bend with the desired angle of the corner. Additionally or alternatively, the outside edge 104 can be attached to an external device or area. For example, the outside edge 104 can be anchored to a floor, wall, the ground or any other desired area. One of skill in the art will appreciate that decorative or identifying design can be cut, embossed, printed or otherwise added to the outside edge 104.

FIGS. 1A, 1B and 1C further show that the corner bracket 100 can include an inside edge 106. In at least one implementation, the inside edge 106 can prevent lateral movement of the boards toward the acute angle of the corner bracket 100. I.e., the inside edge 106 can ensure that the boards do not move toward one another. The inside edge 106 can include a bend. In at least one implementation, the bend can be the same angle as the bend in the outside edge 104. Additionally or alternatively, the inside edge 106 can be attached to an external device or area. For example, the inside edge 106 can be anchored to a floor, wall, the ground or any other desired area. One of skill in the art will appreciate that decorative or identifying design can be cut, embossed, printed or otherwise added to the inside edge 106.

FIGS. 1A, 1B and 1C additionally show that the corner bracket 100 can include a tab 108. In at least one implementation, the tab 108 can be along one portion of the bottom edge 102. As the corner bracket 100 is folded to produce the bend in the outside edge 104, the inside edge 106 and the desired angle, the tab 108 passes through a hole in the outside edge 104. The tab 108 can then be bent, making contact with the outside edge 104. This can hold the corner bracket 100 in the desired shape.

FIGS. 1A, 1B and 1C moreover show that the corner bracket 100 can include one or more attachment means 110 for allowing the corner bracket to attach to a board or other external device. For example, the attachment means 110 can include a hole. The hole can allow a fastener, such as a nail or screw, to pass through the corner bracket 100 and secure the board. Additionally or alternatively, the attachment means 110 can include a tab configured to be driven into the board. I.e., a portion of the bottom edge 102, outside edge 104 or inside edge 106 can be cut and bent in toward the board, then driven into the board.

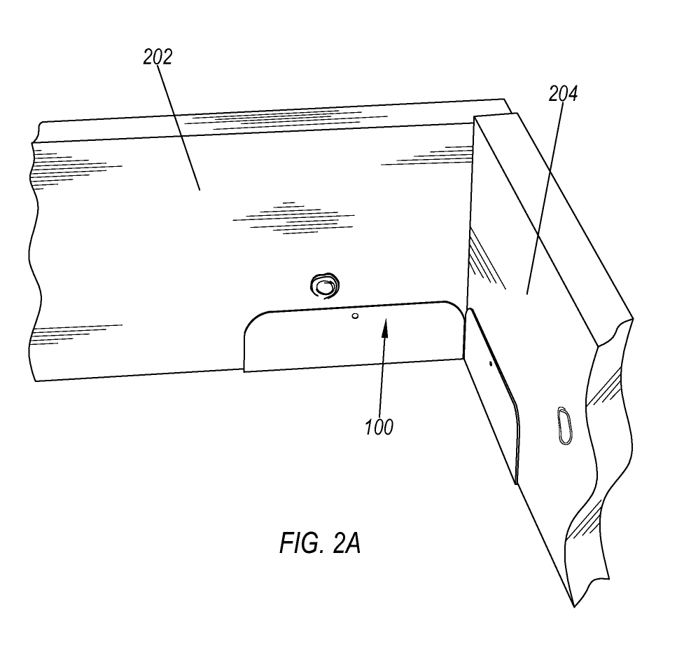

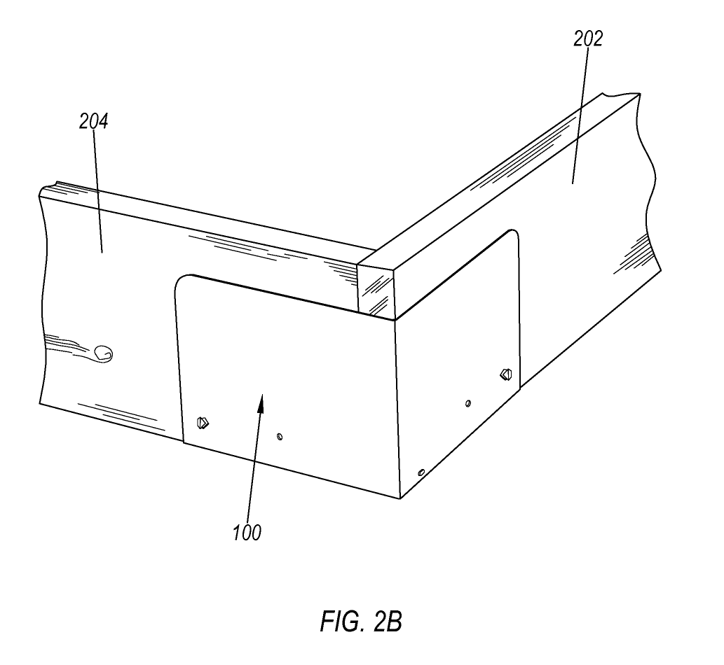

FIGS. 2A and 2B illustrate an example of the corner bracket 100 in use. FIG. 2A illustrates an inside view of the example of a corner bracket 100 in use; and FIG. 2B illustrates an outside view of the example of a corner bracket 100 in use. In at least one implementation, the corner bracket 100 can be manufactured from a single piece of sheet metal. I.e., a piece of sheet metal can be cut and folded into the appropriate shape.

FIGS. 2A and 2B show that a first board 202 and a second board 204 can be inserted into the corner bracket 100. In at least one implementation, the first board 202 and the second board 204 need not be secured to the corner bracket 100. I.e., when in use, the corner bracket 100 must be subject to sufficient lateral forces in two directions simultaneously before being removed. One of skill in the art will appreciate, however, that the first board 202 and the second board 204 can be secured to the corner bracket 100 if so desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A corner bracket, the corner bracket comprising:
a bottom edge;
an outside edge, wherein the outside edge includes a bend; and
an inside edge, wherein the inside edge includes a bend;
wherein the angle of the bend in the outside edge is the same as the angle of the bend in the inside edge.

2. The corner bracket of claim 1, wherein a portion of the corner bracket is configured to receive a board.

3. The corner bracket of claim 2, wherein the portion of the corner bracket is the portion on a first side of the bend on the outside edge.

4. The corner bracket of claim 3, wherein a second portion of the corner bracket is configured to receive a second board.

5. The corner bracket of claim 4, wherein the second portion of the corner bracket is the portion on a second side of the bend on the outside edge;
wherein the second side is opposite the first side.

6. The corner bracket of claim 2, further comprising attachment means configured to secure the bottom edge to the board.

7. The corner bracket of claim 6, wherein the attachment means includes a tab wherein a portion of the tab is configured to be driven into the board.

8. The corner bracket of claim 6, wherein the attachment means includes one or more holes configured to allow a fastener to be driven through the bottom edge and into the board.

9. The corner bracket of claim 2, further comprising attachment means configured to secure the outside edge to the board.

10. The corner bracket of claim 2, further comprising attachment means configured to secure the inside edge to the board.

11. A corner bracket, the corner bracket comprising:
a bottom edge;
an outside edge, wherein the outside edge includes a bend; and
an inside edge, wherein the inside edge includes a bend;
wherein the angle of the bend in the outside edge is the same as the angle of the bend in the inside edge; and
a tab, wherein the tab secures a portion of the bottom edge to the outside edge.

12. The corner bracket of claim 11, wherein the tab is configured to pass through a hole in the outside edge.

13. The corner bracket of claim 12, wherein at least a portion of the tab is bent after passing through the hole in the outside edge, securing the portion of the bottom edge relative to the outside edge.

14. A corner bracket, the corner bracket comprising:
a bottom edge;
an outside edge, wherein the outside edge includes a first bend; and
an inside edge, wherein the inside edge includes a second bend;
wherein the angle of the first bend is the same as the angle of the second bend; and
a tab, wherein the tab secures a portion of the bottom edge on a first side of the first bend to the outside edge on a second side of the first bend.

15. The corner bracket of claim 14, wherein the bottom edge is configured to be attached to an external device.

16. The corner bracket of claim 15, wherein the bottom edge includes one or more holes.

17. The corner bracket of claim 14, wherein the outside edge is configured to be attached to an external device.

18. The corner bracket of claim 17, wherein the outside edge includes one or more holes.

19. The corner bracket of claim 14, wherein the inside edge is configured to be attached to an external device.

20. The corner bracket of claim 19, wherein the inside edge includes one or more holes.
